(19) United States
(12) Patent Application Publication
(10) Pub. No.: US 2025/0157754 A1
(43) Pub. Date: May 15, 2025

(54) PUSH SWITCH

(71) Applicant: ALPS ALPINE CO., LTD., Tokyo (JP)

(72) Inventors: Yoshimasa KURODA, Miyagi (JP); Hiroshi OHARA, Miyagi (JP); Takuya SUZUKI, Miyagi (JP)

(21) Appl. No.: 19/022,459

(22) Filed: Jan. 15, 2025

Related U.S. Application Data
(63) Continuation of application No. PCT/JP2023/008659, filed on Mar. 7, 2023.

(30) Foreign Application Priority Data
Jul. 19, 2022 (JP) 2022-114922

(51) Int. Cl. H01H 13/14; H01H 13/04

(52) U.S. Cl. CPC H01H 13/14; H01H 13/04

(57) ABSTRACT

A push switch includes: a housing including a first accommodating portion; a central fixed contact provided at a bottom of the first accommodating portion; a movable contact member arranged in the first accommodating portion and configured to contact the central fixed contact with a center portion of the movable contact member by inverting of the movable contact member upon receiving a pressing force from above; and a cover member configured to cover an upper portion of the first accommodating portion.

### CROSS-REFERENCE TO RELATED APPLICATIONS

This application is a continuation application of International Application No. PCT/JP2023/008659, filed on Mar. 7, 2023, and designated the U.S., which is based upon and claims priority to Japanese Patent Application No. 2022-114922, filed on Jul. 19, 2022, the entire contents of which are incorporated herein by reference.

### BACKGROUND

### 1. Field of the Invention

The present disclosure relates to a push switch.

### 2. Description of the Related Art

Japanese Laid-Open Patent Application No. 2021-174722 discloses a technique in which, in a push switch provided with a plurality of metal contacts (movable contact members) stacked on top of each other, all of the plurality of metal contacts can be prevented from rotating by providing a pair of rotation stoppers projecting from an outer peripheral edge of each metal contact.

### SUMMARY

A push switch according to one embodiment is provided with a housing including a first accommodating portion; a central fixed contact provided at a bottom of the first accommodating portion; a movable contact member arranged in the first accommodating portion and configured to contact the central fixed contact with a center portion of the movable contact member by inverting the movable contact member upon receiving a pressing force from above; and a cover member configured to cover an upper portion of the first accommodating portion. The movable contact member is formed of a plurality of metal plates stacked on top of each other, a lowermost metal plate arranged at a lowermost position of the plurality of metal plates includes a rotation stopper provided projecting outward from an outer peripheral edge of the lowermost metal plate, the housing includes a second housing portion for accommodating the rotation stopper, and the rotation stopper contacts an inner wall surface of the second housing portion to suppress rotation of the lowermost metal plate, an uppermost metal plate arranged on an uppermost side among the plurality of metal plates does not include the rotation stopper, a pressing member configured to suppress rotation of the uppermost metal plate by pressing a surface of the uppermost metal plate from above is provided between the cover member and the uppermost metal plate, and the pressing member is an insulation sheet configured to cover the movable contact member.

### BRIEF DESCRIPTION OF THE DRAWINGS

FIG. 1 is an external perspective view of a push switch according to one embodiment;

FIG. 2 is an exploded perspective view of the push switch according to the embodiment;

FIG. 3 is a plan view of the push switch according to the embodiment;

FIG. 4 is a cross-sectional view of the push switch according to the embodiment; and

FIG. 5 is a perspective cross-sectional view of a push switch according to another embodiment.

### DETAILED DESCRIPTION OF THE DISCLOSURE

However, in the technique of Japanese Laid-Open Patent Application No. 2021-174722, when a plurality of metal contacts are inverted by pressing performed by a pressing member, the rotation stoppers of the uppermost metal contact closest to a cover sheet provided to cover the plurality of metal contacts jump up from the cover sheet provided to cover the plurality of metal contacts, thereby damaging the cover sheet.

One embodiment will be described in the following with reference to the drawings. In the following description, for convenience, a Z-axis direction in figures is defined as a vertical direction, a Y-axis direction in the figures is defined as a lateral direction, and an X-axis direction in the figures is defined as a front-rear direction. However, a Z-axis positive direction is defined as an upward direction, a Y-axis positive direction is defined as a rightward direction, and an X-axis positive direction is defined as a forward direction.

### Overview of Push Switch 100

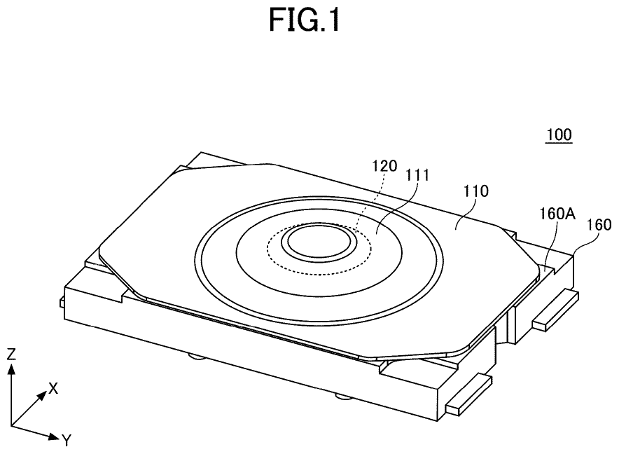

FIG. 1 is an external perspective view of a push switch 100 according to one embodiment. As illustrated in FIG. 1, the push switch 100 generally has a thin and rectangular parallelepiped shape in the vertical direction (Z-axis direction), and when viewed from above, has a rectangular shape in which the lateral direction (Y-axis direction) is the longitudinal direction. As illustrated in FIG. 1, an upper surface 160A of a housing 160 of the push switch 100 is covered with an insulator 110. A protrusion 111 protruding upward (Z-axis positive direction) is formed in a center portion of the insulator 110. A presser 120 is bonded to a back side of the protrusion 111. Thus, the push switch 100 can be pressed downward (in a Z-axis negative direction) by the presser 120, and can be switched from a switched-off state to a switched-on state by the pressing.

### Configuration of Push Switch 100

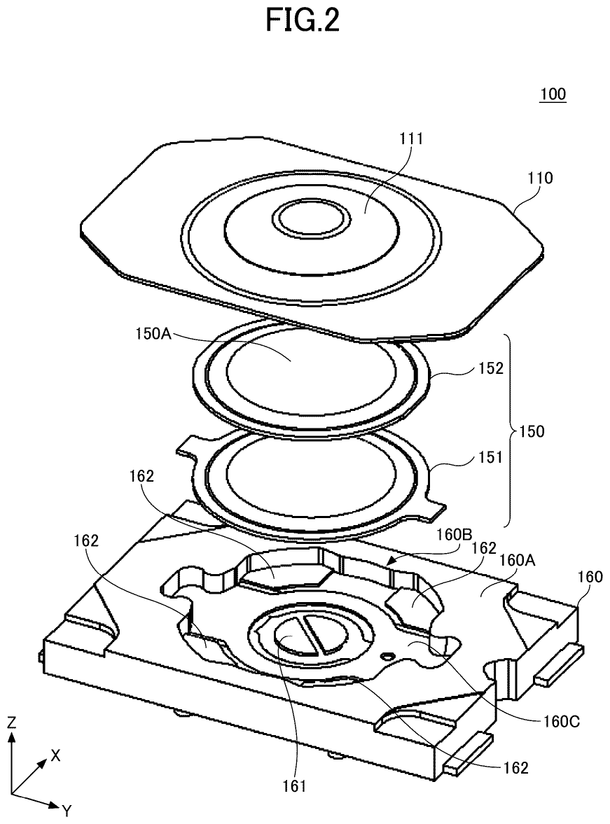

FIG. 2 is an exploded perspective view of the push switch 100 according to the embodiment. As illustrated in FIG. 2, the push switch 100 includes the housing 160, a movable contact member 150, and the insulator 110 in order from a lower side (on a Z-axis negative side) in the figure.

The housing 160 is a container-like member having a thin and rectangular parallelepiped shape in the vertical direction (in the Z-axis direction). The housing 160 has a rectangular shape in which the lateral direction (the Y-axis direction) is the longitudinal direction and the front-rear direction (the X-axis direction) is a transverse direction when viewed from above. The housing 160 includes a first housing portion 160B which is recessed downward from the upper surface 160A. The movable contact member 150 is housed in the first housing portion 160B. For example, the housing 160 is formed by insert molding by using a relatively hard insulating material (for example, hard resins).

A central fixed contact 161 and four peripheral fixed contacts 162 are provided in a bottom portion 160C of the first housing portion 160B of the housing 160. The central fixed contact 161 is provided in a center portion of the bottom portion 160C. The four peripheral fixed contacts 162 are provided in a peripheral portion of the bottom portion 160C. Both the central fixed contact 161 and the peripheral fixed contacts 162 are formed by using a conductive material (for example, metallic materials).

The movable contact member 150 is arranged in the first housing portion 160B of the housing 160. The movable contact member 150 has a dome shape projecting upward (in the Z-axis positive direction) and includes a top portion 150A in the center of the movable contact member 150. The movable contact member 150 receives a pressing force from above and becomes inverted, such that the central portion of the movable contact member 150 contacts the central fixed contact 161 provided at the bottom portion 1600 of the first housing portion 160B of the housing 160. The movable contact member 150 is placed on the four peripheral fixed contacts 162 such that its circular outer periphery contacts each of the four peripheral fixed contacts 162 provided at the bottom portion 160C. of the first housing portion 160B of the housing 160.

The movable contact member 150 is a so-called “invertible spring”, and when pressing is performed by the presser 120, the top portion 150A is pressed downward by the presser 120, and when a predetermined operation load is exceeded, the top portion 150A rapidly and elastically deforms into a recessed shape (inverts). Thus, the movable contact member 150 contacts the central fixed contact 161 at a back side of the top portion 150A, and is electrically connected to the central fixed contact 161. As a result, the movable contact member 150 can make the central fixed contact 161 and the peripheral fixed contacts 162 conductive to each other via the movable contact member 150. When the movable contact member is released from the pressing force of the presser 120, the movable contact member 150 returns to its original projecting shape by an elastic force.

The movable contact member 150 is formed of a stack of a lowermost metal plate 151 arranged on a lowermost side of the movable contact member 150 and an uppermost metal plate 152 arranged on the uppermost side of the movable contact member 150. Both the lowermost metal plate 151 and the uppermost metal plate 152 are dome-shaped members having a circular shape in a plan view from the top and projecting upward (in the Z-axis positive direction). Both the lowermost metal plate 151 and the uppermost metal plate 152 are formed into a dome shape by using thin metal plates.

In the present embodiment, the movable contact member 150 is indicated as a plurality of metal plates being provided on top of each other, but as another indication, it may be indicated as a plurality of movable contact members 150 being provided on top of each other by regarding one metal plate as one movable contact member 150.

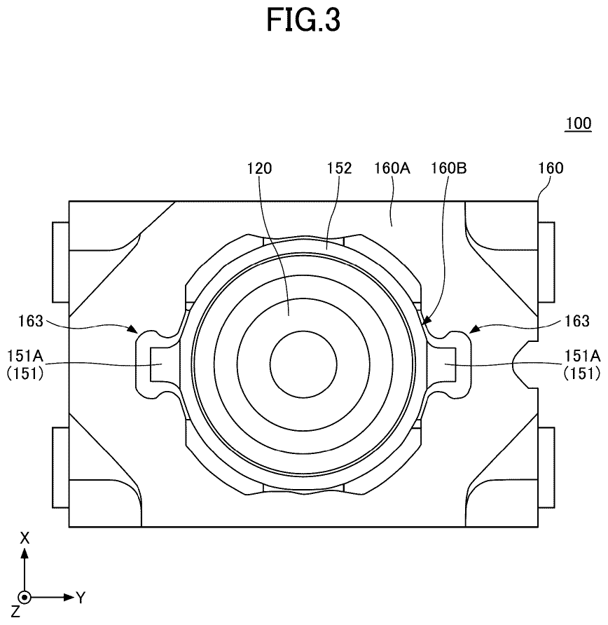

The insulator 110 is a thin sheet-like member arranged on the upper surface 160A of the housing 160. The insulator 110 is an example of a “cover member covering the upper part of the first housing portion”. The insulator 110 is formed of a resin material such as PET. In a plan view from above, the insulator 110 generally has a rectangular shape in which the lateral direction (Y-axis direction) is the longitudinal direction and the front-rear direction (X-axis direction) is the transverse direction. That is, in a plan view from above, the insulator 110 has the substantially same shape as the upper surface 160A of the housing 160 to cover substantially the entire upper surface 160A of the housing 160. The insulator 110 is bonded to the upper surface 160A of the housing 160 by any bonding means (for example, laser welding, etc.) while covering the upper surface 160A of the housing 160. The insulator 110 seals the first housing portion 160B by closing an upper opening of the first housing portion 160B of the housing 160. A protrusion 111 protruding upward (in the Z-axis positive direction) is formed in the center portion of the insulator 110. As illustrated in FIG. 3, a presser 120 is bonded to the back side of the protrusion 111.

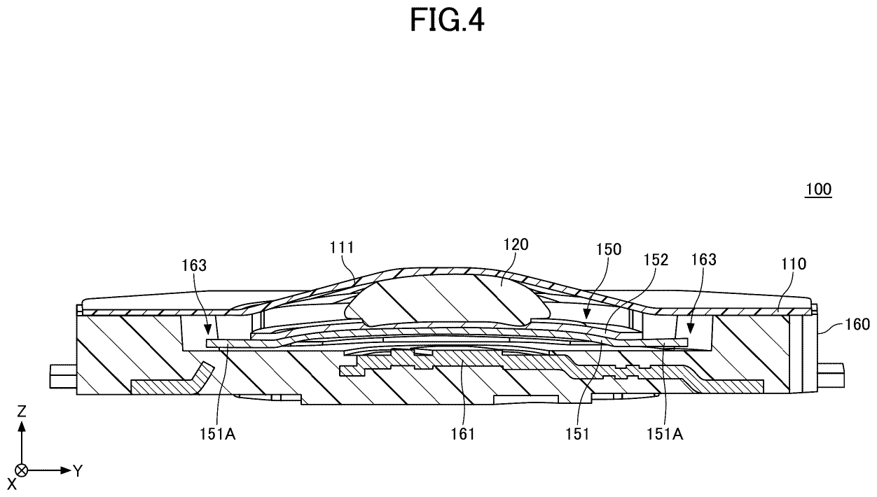

The presser 120 is a member disposed on the top portion 150A of the movable contact member 150 and in a space on the back side of the protrusion 111 of the insulator 110. The presser 120 has a circular shape in a plan view from above (see FIG. 3) and a three-dimensional shape projecting upward from the top portion 150A of the movable contact member 150. The presser 120 is formed by using a resin material such as PA. The presser 120 includes a curved upper surface portion along the protrusion 111 of the insulator 110, and the upper surface portion is bonded to the back side of the protrusion 111 of the insulator 110 by any adhesive means (for example, laser welding, etc.). In the present embodiment, the presser 120 has a three-dimensional shape such that a hemispherical shape is crushed in the vertical direction (Z-axis direction) (see FIG. 4). However, the present embodiment is not limited to this, and the presser 120 may have a cylindrical shape, an ellipsoidal shape, or the like. Furthermore, the presser 120 is not limited to a circular shape in a plan view from above.

### Operation of Push Switch 100

In the push switch 100 according to one embodiment, when no pressing is performed by the presser 120, since the movable contact member 150 is in an initial state of projecting upward, the movable contact member 150 is in contact with the peripheral fixed contacts 162 but not with the central fixed contact 161. That is, the peripheral fixed contacts 162 and the central fixed contact 161 are not conductive to each other. Therefore, the push switch 100 according to one embodiment is in a switched-off state when no pressing is performed by the presser 120.

In the push switch 100 according to one embodiment, when pressing is performed by the presser 120, the presser 120 pushes down the top portion 150A of the movable contact member 150. Then, when the operation load of the pressing by the presser 120 exceeds a predetermined threshold value, the top portion 150A of the movable contact member 150 elastically deforms (inverts) into a recessed shape. Thus, the back side of the top portion 150A of the movable contact member 150 is electrically connected to the central fixed contact 161 by contacting the central fixed contact 161. As a result, the push switch 100 is switched on by conducting the central fixed contact 161 and the peripheral fixed contacts 162 through the movable contact member 150. At this time, the push switch 100 according to one embodiment imparts a click sensation to the pressing by the presser 120 as the movable contact member 150 becomes inverted. Therefore, the push switch 100 according to one embodiment imparts tactile sensation to the operator to understand that the switch is switched on.

In the push switch 100 according to one embodiment, when the pressing by the presser 120 is released, the movable contact member 150 returns to the original projecting shape by its own elastic force. As a result, the push switch 100 returns to the switched-off state.

### Structure of Rotation Stoppers

Rotation stoppers of the push switch 100 according to one embodiment will be described in the following with reference to FIGS. 3 and 4. FIG. 3 is a plan view of the push switch 100 according to one embodiment. FIG. 4 is a cross-sectional view of the push switch 100 according to one embodiment. In FIG. 4, an illustration of the insulator 110 is omitted such that the presser 120 can be visually recognized from above.

The lowermost metal plate 151 has rotation stoppers 151A which project outward in a radial direction from a circular outer peripheral edge. In the present embodiment, as an example, the lowermost metal plate 151 includes two rotation stoppers 151A arranged at 180° intervals (i.e., arranged in point symmetry). Of the two rotation stoppers 151A, one rotation stopper 151A projects in the Y-axis positive direction, and the other rotation stopper 151A projects in a Y-axis negative direction. Both of the two rotation stoppers 151A have a tongue piece shape extending in a horizontal direction (namely, in a direction parallel to an XY plane) from the outer peripheral edge of the lowermost metal plate 151.

The housing 160 includes second housing portions 163 which are recessed from an inner wall surface of the first housing portion 160B toward the outside (outside in the radial direction of a circle formed by the lowermost metal plate 151). The second housing portions 163 house the rotation stoppers 151A of the lowermost metal plate 151. In the present embodiment, while the lowermost metal plate 151 includes two rotation stoppers 151A, the housing 160 includes two second housing portions 163. That is, the housing 160 includes one second housing portion 163 on a Y-axis positive inner wall surface of the first housing portion 160B and another on a Y-axis negative inner wall surface of the first housing portion 160B.

As illustrated in FIGS. 3 and 4, the two rotation stoppers 151A of the lowermost metal plate 151 are respectively housed in a corresponding one of the two second housing portions 163 of the housing 160. Thus, in the push switch 100 according to one embodiment, even when the lowermost metal plate 151 rotates when pressing is performed by the presser 120, each of the two rotation stoppers 151A of the lowermost metal plate 151 contact the corresponding inner wall surface of the two second housing portions 163 of the housing 160, thereby suppressing rotation of the lowermost metal plate 151. Therefore, according to the push switch 100 according to one embodiment, abrasion of the uppermost metal plate 152 and the lowermost metal plate 151 due to friction between the uppermost metal plate 152 and the lowermost metal plate 151 can be suppressed.

When the same rotation stoppers are provided to the uppermost metal plate 152, the rotation stoppers of the uppermost metal plate 152 nearest to the insulator 110 may jump up when the movable contact member 150 becomes inverted, thereby damaging the insulator 110.

Therefore, in the push switch 100 according to one embodiment, the uppermost metal plate 152 does not have the rotation stoppers. Thus, the push switch 100 according to one embodiment can prevent damage to the insulator 110 when the movable contact member 150 becomes inverted.

Note that, in the push switch 100 according to one embodiment, although the uppermost metal plate 152 does not have the rotation stoppers, the uppermost metal plate 152 can be pressed from above by the presser 120, such that rotation of the uppermost metal plate 152 can be suppressed. Therefore, according to the push switch 100 according to one embodiment, abrasion of the uppermost metal plate 152 and the lowermost metal plate 151 due to friction between the uppermost metal plate 152 and the lowermost metal plate 151 can be suppressed.

Note that, in the push switch 100 according to one embodiment, a sufficient distance is provided between the rotation stoppers 151A and the insulator 110 such that even when the rotation stoppers 151A of the lowermost metal plate 151 jump up when the movable contact member 150 becomes inverted, the rotation stoppers 151A do not contact with the insulator 110. Thus, the push switch 100 according to one embodiment can prevent damage to the insulator 110 when the movable contact member 150 becomes inverted.

### Another Embodiment

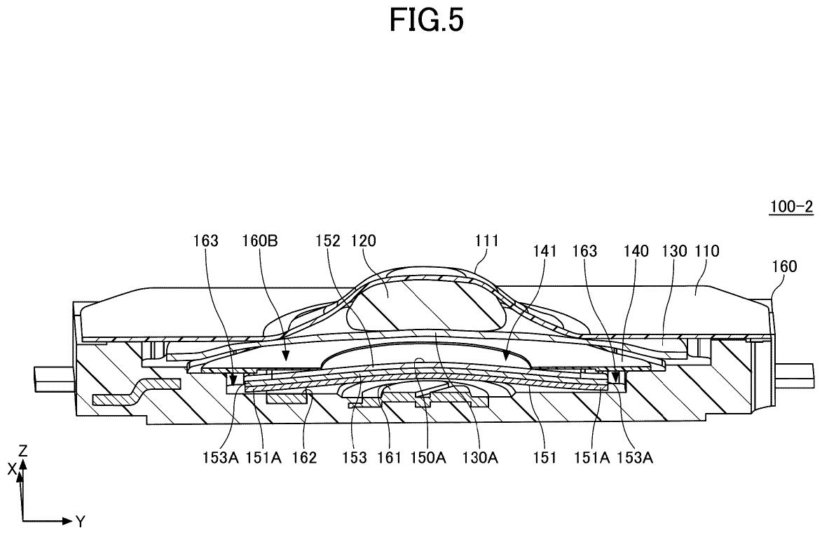

FIG. 5 is a perspective cross-sectional view of a push switch 100-2 according to another embodiment. The push switch 100-2 according to the present embodiment as illustrated in FIG. 5 is a modified example of the push switch 100 according to one embodiment. As illustrated in FIG. 5, the push switch 100-2 is similar to the push switch 100 according to one embodiment in that it includes the housing 160, the insulator 110, and the presser 120. However, the push switch 100-2 differs from the push switch 100 in that it includes, in order from a lower side, a movable contact member 150, an insulation sheet 140, and a second movable contact member 130 in the first housing portion 160B of the housing 160.

The second movable contact member 130 is arranged on an upper side of the movable contact member 150 in the first housing portion 160B of the housing 160. The second movable contact member 130 has a dome shape projecting upward (in the Z-axis positive direction) with a top portion 130A at the center of the second movable contact member 130. The second movable contact member 130 is formed into a dome shape by using a thin metal plate. The second movable contact member 130 is in contact with a second peripheral fixed contact (not illustrated) provided in the first housing portion 160B of the housing 160, and is electrically connected to the second peripheral fixed contact. The second movable contact member 130 is a so-called “invertible spring”, and when pressing is performed by the presser 120, the top portion 130A is pressed downward by the presser 120, and when the predetermined operation load is exceeded, the top portion 130A is rapidly and elastically deformed into a recessed shape (inverts). Thus, the second movable contact member 130 is brought into contact with the top portion 150A of the movable contact member 150 at a back side of the top portion 130A, and is electrically connected to the peripheral fixed contacts 162 via the movable contact member 150. When the second movable contact member 130 is released from the pressing force of the presser 120, the second movable contact member 130 returns to its original projecting shape by an elastic force.

The insulation sheet 140 is formed of an insulating material. It is a sheet-like member. The insulation sheet 140 is arranged between the second movable contact member 130 and the movable contact member 150 in the first housing portion 160B of the housing 160. Thereby, the insulation sheet 140 insulates the second movable contact member 130 and the movable contact member 150 from each other such that they are not electrically connected to each other when the push switch 100 is not pressed. A circular opening 141 is formed in a center portion of the insulation sheet 140. The insulation sheet 140 is configured to bring the back side of the top portion 130A of the second movable contact member 130 into contact with the top portion 150A of the movable contact member 150 through the opening 141 when the presser 120 is pressed.

### Operation of Push Switch 100-2

In the push switch 100-2 according to the present embodiment, when the presser 120 performs a halfway pushing, the presser 120 pushes down the top portion 130A of the second movable contact member 130 and elastically deforms (inverts) the top portion 130A of the second movable contact member 130 into a recessed shape. As a result, the second movable contact member 130 is electrically connected to the peripheral fixed contacts 162 via the movable contact member 150 by contacting the back side of the top portion 130A with the top portion 150A of the movable contact member 150. As a result, the push switch 100-2 is switched to a first switched-on state when the second peripheral fixed contact and the peripheral fixed contacts 162 become conductive to each other via the movable contact member 150 and the second movable contact member 130. At this time, the push switch 100-2 according to the present embodiment imparts a click sensation to the halfway pushing by the presser 120 as the second movable contact member 130 becomes inverted. Therefore, the push switch 100-2 according to the present embodiment imparts tactile sensation that the push switch is switched to the first switched-on state.

When the push switch 100-2 according to the present embodiment is fully pushed by the presser 120, the presser 120 further pushes down the top portion 130A of the second movable contact member 130. Thus, the second movable contact member 130 pushes down the top portion 150A of the movable contact member 150 at the back side of the top portion 130A and elastically deforms (inverts) the top portion 150A of the movable contact member 150 into a recessed shape. Thus, the back side of the top portion 150A of the movable contact member 150 is electrically connected to the central fixed contact 161 by contacting the central fixed contact 161. As a result, the push switch 100-2 is switched to a second switched-on state when the central fixed contact 161 and the peripheral fixed contacts 162 are conductive to each other via the movable contact member 150. At this time, the push switch 100-2 according to one embodiment imparts a click sensation to the full pushing by the presser 120 as the movable contact member 150 becomes inverted. Therefore, the push switch 100-2 according to the present embodiment imparts tactile sensation to the operator to understand that the switch is switched to the second switched-on state.

In the push switch 100-2 according to the present embodiment, when the halfway pushing and the full pushing by the presser 120 are released, the movable contact member 150 returns to the original projecting shape by its own elastic force, and the second movable contact member 130 returns to the original projecting shape by its own elastic force. As a result, the push switch 100-2 returns to the switched-off state.

### Structure of Rotation Stoppers

In the push switch 100-2 according to the present embodiment, the movable contact member 150 includes the lowermost metal plate 151 arranged on the lowermost side, an uppermost metal plate 152 arranged on the uppermost side, and an intermediate metal plate 153 arranged between the lowermost metal plate 151 and the uppermost metal plate 152. That is, in the push switch 100-2 according to the present embodiment, the movable contact member 150 includes three metal plates stacked on top of each other. Each of the lowermost metal plate 151, uppermost metal plate 152, and intermediate metal plate 153 has a circular shape in a plan view from above and is a dome-shaped member projecting upward (in the Z-axis positive direction). Each of the lowermost metal plate 151, the uppermost metal plate 152, and the intermediate metal plate 153 is formed into a dome shape by using a thin metal plate.

In the push switch 100-2 according to the present embodiment, the lowermost metal plate 151 includes the rotation stoppers 151A which project outward in the radial direction from the circular outer peripheral edge. Similarly, the intermediate metal plate 153 includes rotation stoppers 153A which project outward in the radial direction from the circular outer peripheral edge.

As illustrated in FIG. 5, each of the two rotation stoppers 151A of the lowermost metal plate 151 and each of the two rotation stoppers 153A of the intermediate metal plate 153 are correspondingly housed in the two second housing portions 163 of the housing 160. Thus, in the push switch 100-2 according to the present embodiment, even when the lowermost metal plate 151 and the intermediate metal plate 153 rotate when pressing is performed by the presser 120, the rotation of the lowermost metal plate 151 and the intermediate metal plate 153 can be suppressed by bringing each of the two rotation stoppers 151A of the lowermost metal plate 151 and each of the two rotation stoppers 153A of the intermediate metal plate 153 into contact with the corresponding inner wall surface of the two second housing portions 163 of the housing 160. Therefore, according to the push switch 100-2 according to the present embodiment, abrasion of the uppermost metal plate 152, the intermediate metal plate 153, and the lowermost metal plate 151 due to friction between the intermediate metal plate 153 and the lowermost metal plate 151, and friction between the uppermost metal plate 152 and the intermediate metal plate 153 can be suppressed.

In the push switch 100-2 according to the present embodiment, the uppermost metal plate 152 does not include the rotation stoppers. Thus, the push switch 100-2 according to the present embodiment can prevent damage to the insulation sheet 140 (another example of a “cover member”) when the movable contact member 150 becomes inverted.

In the push switch 100-2 according to the present embodiment, although the uppermost metal plate 152 does not include the rotation stoppers, the uppermost metal plate 152 can be pressed from above by the insulation sheet 140 (another example of a “pressing member”), and therefore rotation of the uppermost metal plate 152 can be suppressed. Therefore, according to the push switch 100-2 according to the present embodiment, abrasion of the uppermost metal plate 152 and the intermediate metal plate 153 due to friction between the uppermost metal plate 152 and the intermediate metal plate 153 can be suppressed.

As described above, when the movable contact member 150 includes the intermediate metal plate 153, it is preferable to provide the rotation stoppers 153A on the intermediate metal plate 153 as well. When the movable contact member 150 includes a plurality of intermediate metal plates 153, it is preferable to provide the rotation stoppers 153A on each of the plurality of intermediate metal plates 153.

According to one embodiment, abrasion of the movable contact member and damage of the cover member can be suppressed.

Although embodiments of the present invention have been described in detail above, the present invention is not limited to these embodiments, and various modifications or changes can be made within the scope of the gist of the present invention described in the claims.

What is claimed is:

1. A push switch, comprising:
a housing including a first accommodating portion;
a central fixed contact provided at a bottom of the first accommodating portion;
a movable contact member arranged in the first accommodating portion and configured to contact the central fixed contact with a center portion of the movable contact member by inverting the movable contact member upon receiving a pressing force from above; and
a cover member configured to cover an upper portion of the first accommodating portion, wherein
the movable contact member is formed of a plurality of metal plates stacked on top of each other,
a lowermost metal plate arranged at a lowermost position of the plurality of metal plates includes a rotation stopper provided projecting outward from an outer peripheral edge of the lowermost metal plate,
the housing includes a second housing portion for accommodating the rotation stopper, and the rotation stopper contacts an inner wall surface of the second housing portion to suppress rotation of the lowermost metal plate,
an uppermost metal plate arranged on an uppermost side among the plurality of metal plates does not include the rotation stopper,
a pressing member configured to suppress rotation of the uppermost metal plate by pressing a surface of the uppermost metal plate from above is provided between the cover member and the uppermost metal plate, and
the pressing member is an insulation sheet configured to cover the movable contact member.

2. A push switch, comprising:
a housing including a first accommodating portion;
a central fixed contact provided at a bottom of the first accommodating portion;
a movable contact member arranged in the first accommodating portion and configured to contact the central fixed contact with a center portion of the movable contact member by inverting the movable contact member upon receiving a pressing force from above; and
a cover member configured to cover an upper portion of the first accommodating portion, wherein
the movable contact member is formed of a plurality of metal plates stacked on top of each other,
a lowermost metal plate arranged at a lowermost position of the plurality of metal plates includes a rotation stopper provided projecting outward from an outer peripheral edge of the lowermost metal plate,
the housing includes a second housing portion for accommodating the rotation stopper, and the rotation stopper contacts an inner wall surface of the second housing portion to suppress rotation of the lowermost metal plate,
an uppermost metal plate arranged on an uppermost side among the plurality of metal plates does not include the rotation stopper,
a pressing member configured to suppress rotation of the uppermost metal plate by pressing a surface of the uppermost metal plate from above is provided between the cover member and the uppermost metal plate,
the movable contact member includes an intermediate metal plate arranged between the lowermost metal plate and the uppermost metal plate, and
the intermediate metal plate includes the rotation stopper.

3. The push switch according to claim 2, wherein
the movable contact member includes a dome portion, and
the pressing member is a presser configured to press a top portion of the dome portion of the movable contact member.

4. The push switch according to claim 1, wherein
the movable contact member has a substantially circular outer shape.

5. The push switch according to claim 1, wherein
the rotation stopper extends in a horizontal direction from the outer peripheral edge of the lowermost metal plate.

6. The push switch according to claim 2, wherein
the lowermost metal plate includes two of the rotation stoppers arranged in point symmetry.
